(19) United States
(12) Patent Application Publication
(10) Pub. No.: US 2025/0217111 A1
(43) Pub. Date: Jul. 3, 2025

(54) COMBINATORIAL DECOMPOSITION FOR ADDITIVE VALUES OF FACTORS IN EQUATIONS

(71) Applicant: Caret Holdings, Inc., Columbus, OH (US)

(72) Inventors: Jason Christopher Randal Miller, Naperville, IL (US); Derrick Christopher Spell, Oswego, IL (US)

(21) Appl. No.: 18/399,385

(22) Filed: Dec. 28, 2023

(51) Int. Cl. G06F 7/544

(52) U.S. Cl. CPC G06F 7/544

(57) ABSTRACT

Factors of an equation are decomposed into additive values by factor. A total contribution value or total impact of each factor in the equation is determined. The total contribution value of each factor is integrated into a network service and/or user interface for analyzing how changes in values of each of the factors of the equation will impact the result of the equation.

A variety of consumer-based service fees and corresponding regulations are based on calculation of equations, which include a multitude of factors multiplied together against a base rate. For example, insurance rates include consumer-selected coverages and consumer-based attributes or characteristics, which are translated into factors and multiplied together against a base coverage to determine a given consumer's insurance rate or insurance quote. Each jurisdiction for which insurance is provided may also include regulations regarding each of the offered coverages, consumer-based attributes or characteristics, and corresponding factors.

When multiple factors are multiplied together against a base rate in a lengthy equation, it becomes difficult for the consumer and regulators to evaluate what each factor actually contributes to the overall insurance rate or insurance quote. Simply, comparing a given factor against a sum of all the factors does not adequately provide the given factor's overall contribution to the result of the equation. This can be frustrating to consumers when trying to adjust coverages in order to obtain a desired rate and makes it difficult for insurers to prove compliance to regulators.

### BRIEF DESCRIPTION OF THE DRAWINGS

FIG. 1 is a diagram of a system for combinatorial decomposition for additive values of factors in equations, according to an example embodiment.

FIG. 2A is a visual illustration of an overall volume and individual volumes associated with two factors multiplied by a base in an equation, according to an example embodiment.

FIG. 2B is another visual illustration of the additive values contributed by each factor relative to the base for the example equation depicted in FIG. 2, according to an example embodiment.

FIG. 3 is a diagram of flow diagram for rendering additive values of factors in an equation via an interface, according to an example embodiment.

FIG. 4 is a flow diagram of another method for providing additive values of factors in an equation, according to an example embodiment.

### DETAILED DESCRIPTION

In various embodiments, methods and a system for determining, providing, and integrating additive values of factors associated with an equation used by a network service. The base and factors for the equation are identified. The additive volumes of each factor, and each combination of the factors are determined and a contribution value of each factor in the equation is calculated. The contribution value of each factor is integrated into a network service or a user interface of a consumer, actuary, and/or regulator. The network service provides the equation to consumers, actuaries, and/or regulators along with selections associated with the factors and the contribution value for each factor of the equation. The consumer, actuary, and/or regulator can rapidly comprehend the impact of decreasing a value of a given factor and its effect in the overall result of the equation.

For example, consider a consumer searching for an acceptable insurance quote. The insurer provides a number of selections to the consumer related to attributes or characteristics relevant to providing an insurance quote. The attributes or characteristics translate to factors and values of factors, which are then multiplied together to provide an insurance quote to the consumer. For example, one factor is likely linked to the vehicle type being insured, age of the vehicle, accident history of the vehicle or vehicle type, etc. The consumer is considering purchasing one of several different vehicles and is shopping through an insurer's network service for a low cost car insurance policy. Conventionally, the consumer is unable to comprehend why when the consumer selects a less costly vehicle over a luxury vehicle as the vehicle type, the overall insurance rate quotes provided through the network service of the insurer does not decrease in price as much as the consumer expected that it would. This is because there are a multiple of factors in the equation used to calculate an insurance quote. Each factor has a different level of contribution to the overall result of the equation (i.e., the result of the equation can be viewed and the insurance quoted rate or cost). The consumer can endlessly make selections of coverages, attributes, and selections for different factors and never obtain a quote that seems reasonable to the customer; as a result, most consumers become extremely frustrated with the network service and correspondingly the insurer because the quotes provide seem illogical and remain a black box to the consumer.

As another example, an actuary for an insurer is considering changing a calculation for a given factor but has no way of knowing, with what seems to be a small and insignificant change, what the overall effect will be on the calculated rates in the insurance rate equation because the factor is one of several factors that are multiplied together to determine the final quoted rate to consumers. Conventionally, the actuary has to run through a multitude of example consumer selections or process multiple simulations before the actuary can finally feel comfortable in making the change to the calculation of a given factor. This is costly, time consuming, and prone to mistakes.

In still another example, consider an insurer that is attempting to demonstrate to a regulator that a given factor, which the regulator may restrict or monitor, is below the given impact on an overall insurance quoted rate to a consumer. Because the insurer does not know the actual contribution of the factor relative to all the factors in the equation, it is time consuming and difficult for the insurer to prove to the regulator that the insurer is in compliance with respect to the given factor.

All of the aforementioned issues are solved with the teachings presented herein. Each factor, and each combination of factors in a given equation is analyzed and the overall contribution of each factor to a result of the equation is determined. Each contribution for each of the factors in the equation are integrated into interfaces and network services where the equation is evaluated and calculated providing control to users of the interfaces and services to comprehend, analyze, and manipulate results of the equation through user changes that affect the factors.

As used herein, “justly” is used as an adjective and is intended to mean proportional. Thus, when a factor includes a “justly attributed value,” the value is intended to mean a proportionally distributed value assigned to the factor relative to other factors.

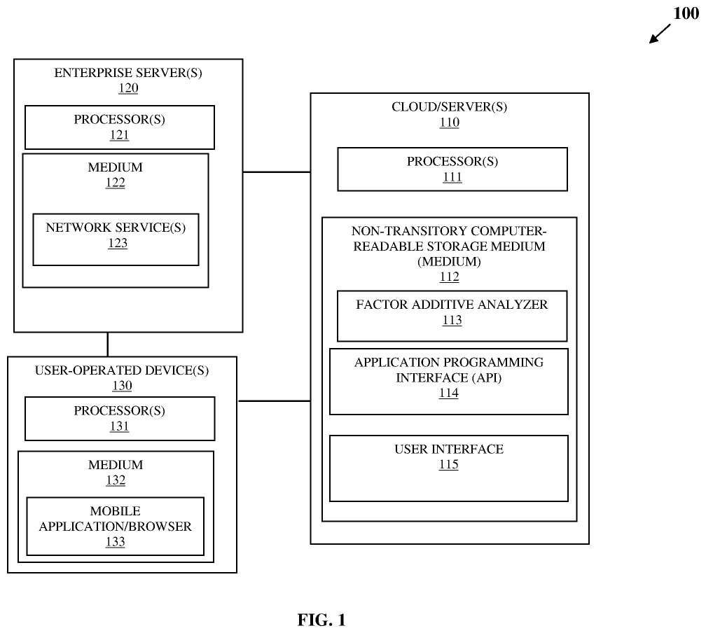

FIG. 1 is a diagram of a system 100 for providing and integrating an equation-based processing data structure into network services, system services, mobile applications and/or browsers, according to an example embodiment. Notably, components of system 100 are shown in simplified form with just those components necessary for comprehending the teachings presented herein being illustrated. More or less components are intended to fall within the scope of the beneficial teachings presented herein.

System 100 includes at least one cloud 110 or server 110 (herein after just “cloud 110”), a plurality of enterprise servers 120, and a plurality of user-operated devices (herein after just “devices”) 130. Cloud 110 includes at least one processor 111 and a non-transitory computer-readable storage medium (herein after just “medium”) 112, which includes instructions for a factor additive analyzer 113, an application programming interface (API) 114, and user interface 115. When the processor 111 executes the instructions, this causes the processor 111 to perform operations discussed herein and below with respect to 113-115.

Each enterprise server 120 includes at least one processor 121 and medium 122, which includes instructions for one or more network services 123. When the processor 121 executes the instructions, this causes the processor 121 to perform operations discussed herein and below with respect to 123.

Each device 130 includes at least one processor 131 and medium 132, which includes instructions for a mobile application (hereinafter just “app”)/browser 133. When the processor 131 executes the instructions, this causes the processor 131 to perform operations discussed herein and below with respect to 133.

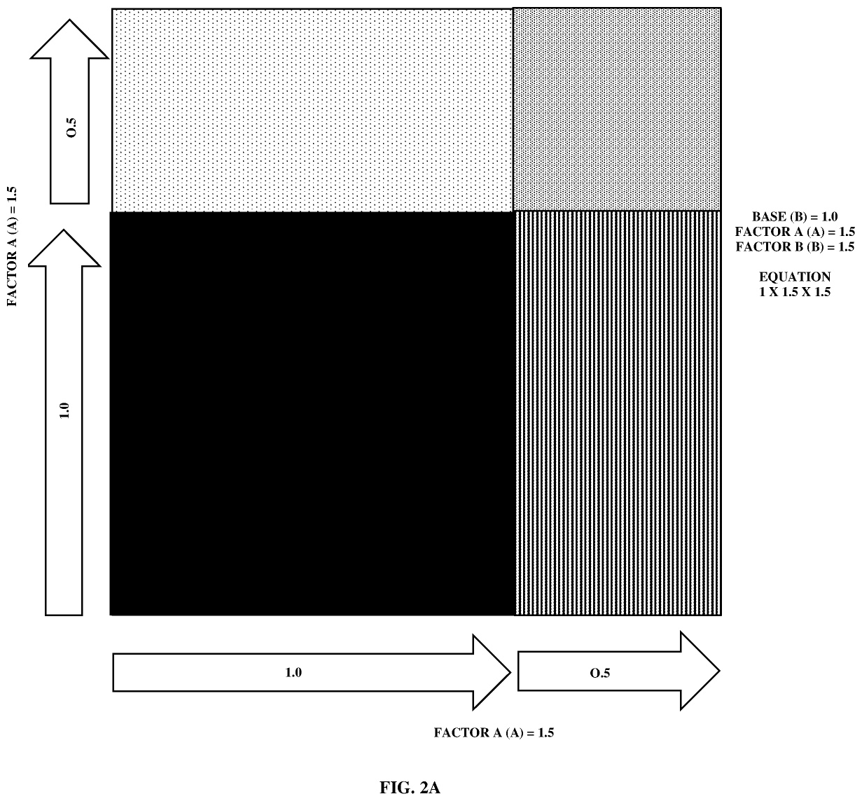

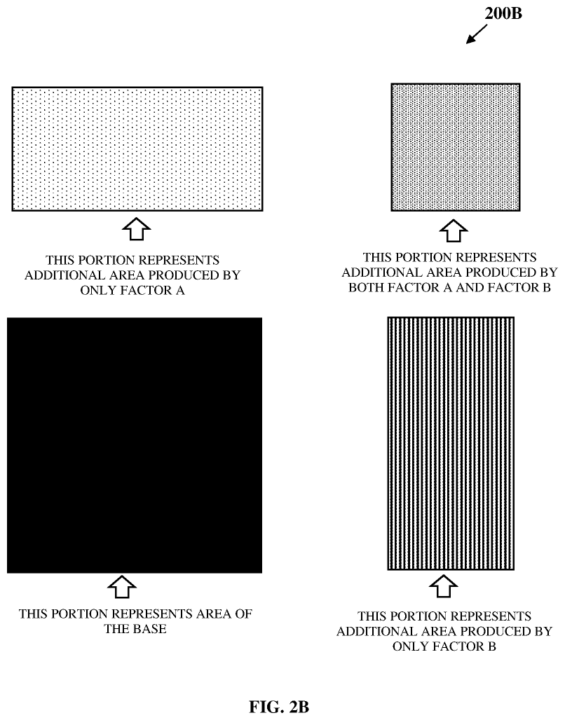

FIG. 2A is a visual illustration of an overall volume and individual volumes associated with two factors multiplied by a base in an equation, according to an example embodiment. Rates are the product of their factors and a base rate. A base rate of 100 and two factors of 1.5 is computed as 100×1.5×1.5, which is 225. To quantify the portion discretely contributed by a specific factor is more challenging and not necessarily intuitive. One cannot simply divide the total by the factor to get the correct portion. 225−(225/1.5) is 75, so using that approach would suggest that each of the two factors above each contributed 75 to the total, which clearly is not possible since they sum to 250.

A visual representation of the above example is presented in FIG. 2A to clarify the contributions of each factor in the equation. For simplicity's sake only two factors are presented, both of which can be applied to the base later to get a final premium for the equation. Alternatively, the back can be expressed as a base rate of 1.0 or 100% and later scaled to get the correct base rate. In FIG. 2A, the premium can be understood as the area covered by a square with sides whose lengths are factors. In this case the sides are each 1.5, so the area is 2.25, which when multiplied against the base rate produced the expected 225. As shown in FIG. 2A, each portion of the whole square can be attributed to some number of specific factors.

FIG. 2B is another visual illustration of the additive values contributed by each factor relative to the base for the example equation depicted in FIG. 2, according to an example embodiment. Continuing with the simplified base rate of 1.0, which can be scaled to the 100 at a later time, the square in the lower left (i.e., black square) has an area of 1.0. This would be the total premium if all factors were 1.0, with none of them increase or decreasing the premium. The top left rectangle (i.e., the whitest rectangle with a dot pattern) represents the additional premium that is exclusively attributed to factor A. The dimensions are 0.5 and 1.0, so additive area (delta area over base of 1.0) is 0.5. The bottom right rectangle (i.e., the black and white rectangle with a black vertical line pattern) represents the additional premium that is exclusive attributable to factor B. The dimensions are 0.5 and 1.0, so the additive area is 0.5. The top right square (i.e., the rectangle with a dark and denser dot pattern) represents the additional premium that is the result of both factor A and factor B. Its dimensions are 0.5 and 0.5, so the additive area is 0.25.

Adding all the additive areas produces 2.25, which can be scaled back to the 225 using the original base rate of 100. Since both factors in this example are equal, it can be expected that the top right square has an equal contribution from each factor, so one can reasonably split the premium represented by it in half, attributing 0.125 to each factor A and factor B. Since their exclusive portions were each 0.5, with their fair share of the top right square, it is clear that factor A and factor B, each contributed 0.625. That is, factor A contributed 0.5 in the top left rectangle plus 0.125 in the top right square which is equal to 0.625. Similarly, factor B contributed 0.5 in the bottom right rectangle plus 0.125 in the top right square which is equal to 0.625.

Returning to the full premium, the total premium can be described as the base rate plus the sum of all factor premiums (i.e., the premium justly attributable to each factor.

base rate+factor A premium+factor B premium=total premium

Scaling each of the components by the actual unscaled base rate, the premium equation is $100+$62.50+$62.50=$225.

The attribution of the portion represented in the top right square in this example was trivial and intuitive, since each factor had the same weight, their portions must be equal. As a general rule, one can split the portions by ratio. For example, factors 1.1 and 1.4 would be attributable for 20% and 80%, since 0.4 is four times 0.1. Stated another way, factor 1.1−1 is 0.1; factor 1.4-1 is 0.4; 0.1+0.4 is 0.5; 0.1/0.5 is 0.2 or 20% for factor 1.1; and 0.4/0.5 is 0.8 or 80% for factor 1.4.

Of course, factors can be less than one as well, and the match gets more complicated when trying to attribute portions with them. Intuition might suggest that the fair portion would be relative to the factor's distance from 1.0, such that 0.5 and 1.5 should each own half of the top right rectangle's area. However, 0.5 has a stronger impact on the premium result for the equation than 1.5, in fact, double the impact. If the two factors had equal but opposite impact, the out to cancel out, but 0.5, or ½, would be negated by 2.0, not 1.5, and 1.5's contribution would be 0.66667, or ⅔. In order to justly attribute each factor's portion, the factors are normalized such that each normalized value divided by the sum of all normalized values contributing to the area are the percentage justly attributable to each factor. The normalized factors are referred to as the impacts of the factors herein and below. Factor additive analyzer 113 calculates the normalized factors as follows:

When the factor is less than 1.0:

impact=(1.0/factor)−1.

When the factor is greater than 1:

impact=factor−1.

Using this model, 0.5 and 2.0 both have an impact of 1. 0.66667 and 1.5 also have a same impact of 0.5. Notably, other methods of proportioning the areas across the component factors can be used with the teachings presented herein so long as the sum of the individual factor premiums plus the base premium total correctly with the equation.

In this simplified example, only two factors A and B were illustrated; however, for most insurance rating plans, the premium equations can have upwards of 20 factors. Thus, the approach discussed is scaled to n dimensions, where n is the number of factors. With more than 2 factors, the areas become volumes.

The factor additive analyzer 113 takes the following scaling approach for n dimensions of factors in a given equation. The factor additive analyzer 113 identifies all discrete n-dimensional volumes described by the factors. For two factors, four areas are found, for three factors eight areas of a cube are found, etc. The factor additive analyzer 113 identifies the individual volumes represented in the equation as mathematical combinations, nCr, where n is the number of factors and r is in the ranges of 1 to n. Essentially, all combinations of factors with a size of 1 to n dimensions.

Next. the factor additive analyzer 113 finds all the volumes identified with a factor as a member. For each volume, 1 is subtracted from each factor because 1 represents what the base rate already contributes, each factor with 1 subtracted is then multiplied by any remaining factors that are part of a given volume and a given combination of factors. This result is then multiplied by a corresponding factor's impact (as discussed above) and the base rate. The result is the premium which is attributed to the corresponding factor for each volume. The factor additive analyzer 113 sums each factor's attributed premium for each volume in which the factor is a part of to obtain a total contribution value of the corresponding factor. The sum of all factors' total contribution values is equal to the product of the base rate and all the factors (e.g., base rate X factor 1 . . . factor n).

To further illustrate how the factor additive analyzer determines the individual total contribution value of each factor in a given equation another example is presented. Consider a base rate of 1, factor A is 0.5, factor B is 1.5, and factor C is 2.0; the product of the equation is known to be 1×0.5×1.5×2.0 or 1.5. the factor additive analyzer 113 knows that 1+the total premium or contribution of factor A+the total premium of contribution value of factor B+the total premium of contribution of factor B is equal to 1.5, the base contributes 1.0; therefore, the total premium or contribution of factor A+the total premium of contribution value of factor B+the total premium of contribution of factor B is equal to 0.5.

The factor additive analyzer 113 calculates premiums for each combination of factors and splits justly across contributing factors. The factor additive analyzer 113 calculates derivatives of the factors relative to 1, the identify value, where multiplication is idempotent. This is done by subtracting 1 from each factor, the result is referred to as factor deltas such that factors greater than 1 will derive a factor delta with a positive value, indicating the corresponding factor increases the total premium. Factors lower than 1 derive a delta with a negative value, indicating that the corresponding factor decreases the total premium. Factors that are exactly 1 derive a delta of 0, indicating the corresponding factors have no impact on the total premium.

The factor additive analyzer 113 calculates the deltas for factors A, B, and C as follows: factor delta A is 0.5-1.0=−0.5; factor delta B is 1.5-1.0=0.5; factor delta C is 2.0-1.0=1.0. Next, the factor additive analyzer 113 computes the products of all combinations of the factors in the equation using the factor derivatives. These combinations represent discrete n-dimensional volumes described by the constituent factors, and the portion of the total premium attributed to the corresponding combination of factors. There are 7 total combinations of factors as follows A, B, C, AB, AC, BC, and ABC; note that single factor combinations A, B, and C are 3 of the 7 total combinations.

The factor additive analyzer 113 calculates the additive volume of each combination as follows A=factor A delta=−0.5; B=factor B delta=0.5; C=factor C delta=1.0; AB=factor A delta (−0.5) X factor B delta (0.5)=−0.25; AC=factor A delta (−0.5) X factor C delta (1.0)=−0.5; BC=factor B delta (0.5)×factor C delta (1.0)=0.5; ABC=factor A delta (−0.5) X factor B delta (0.5)×factor C delta (1.0)=−0.25. The factor additive analyzer 113 can check to ensure these are correct volumes by adding the volumes to ensure that the sum of the individual volumes is=to the sum of the additive premiums to the base by adding (−0.5) (A's additive volume)+(0.5) (B's additive volume)+1 (C's additive volume)+(−0.25) (AB's additive volume)+(−0.5) (AC's additive volume)+(0.5) (BC's additive volume)+(−0.5) (ABC's additive volume)=0.5, which matched total premium A+total premium B+total premium C as was shown above.

Next, the factor additive analyzer 113 calculates the just attributions or contribution values for each factor in each volume. The factor additive analyzer 113 processes a just attribution function as follows for each factor in each volume:

```
  Just Attribution for Factor N in Volume (N ...)
  Impact N / Sum of Impacts N ...
Where ...
  Impact for Factor N =
    If Factor N < 1 (1 /Factor N)
    Else
    Factor N - 1
```

Each just attribution is a percentage, and the sum of the attributions for a given volume will sum to 100%. For a volume that includes just 1 factor, the attribution of that factor is 100%. Impact per factor is computed independent of volume. Impact is another derivative of the factor, this time along a curve that synchronizes factors above 1 with their corresponding “canceling” factors below 1. For example, a factor of 2 would be canceled out by a factor of 0.5, since 2×0.5=1, the same as if the factors were not present. The impact for 2 and 0.5 are the same, both 1, which the just attribution calculation will regard as equal contribution to the volume.

The factor additive analyzer 113 calculates the just attribution or contribution values by first calculating the impact of each factor as A=(1/0.5)−1=1′ B=1.5−1=0.5; C=2−1=1. The just attributions for each of the 7 combinations of volumes is calculated as: A=100% or 1; B=100% or 1; C=100% or 1; just attribution of A in AB=0.5 (impact A)/(1 (impact A)+0.5 (impact B))=1/1.5˜=66.7% or 0.666667; just attribution of B in AB=0.5 (impact B)/(1 (impact A)+0.5 (impact B))=0.5/1.5˜=33.33% or 0.333333 . . . 3; just attribution of A in AC=1 (impact A)/(1 (impact A)+1 (impact C))=1/2=50% or 0.5; just attribution of C in AC=1 (impact C)/(1 (impact A)+1 (impact C)=1/2=50% or 0.5; just attribution of B in BC=0.5 (impact B)/(0.5 (impact B)+1 (impact C))=0.5/1.5˜=33.33% or 0.333333 . . . 3; just attribution of C in BC=1 (impact C)/(0.5 (impact B)+1 (impact C))=1/1.5 ˜=66.7% or 0.666666 . . . 6; just attribution of A in ABC=1.0 (impact A)/(1 (impact A)+0.5 (impact B)+1 (impact C))=1/2.4=40% or 0.4; just attribution of B in ABC=0.5 (impact B)/(1 (impact A)+0.5 (impact B)+1 (impact C))=0.5/2.5=20% or 0.2; and just attribution of C in ABC=1 (impact C)/(1 (impact A)+0.5 (impact B)+1 (impact C))=1/2.5=40% or 0.4.

The factor additive analyzer 113 uses the just attributions for each factor to calculate the total just attributions per volume using each factor's corresponding delta in each volume. This should be equal to the additive volumes calculated above for the factor deltas and can be performed by the factor additive analyzer 113 as a check to verify the just attributions of each of the factors. The factor additive analyzer 113 calculates the just attributions for the 7 volumes as follows: just attribution of volume A is −0.5 (factor A delta)×1 (100% just attribution for A in volume A)=−0.5; just attribution of volume B is 0.5 (factor B delta)×1 (100% attribution for B in volume B)=0.5; just attribution of volume C is 1 (factor C delta)×1 (100% attribution for C in volume C); just attribution of volume AB is (−0.25 (AB delta) X.666666 (just attribution of A in AB))+(−0.25 (AB delta) X.333333 (just attribution of B in AB))˜=−0.1667+−0.0833˜=−0.25; just attribution of volume BC is (0.333333 (just attribution of B in BC)×0.5 (BC delta))+(0.666666 (just attribution of C in BC)×0.5 (BC delta)˜=0.166666+0.333333˜=0.5; just attribution of volume AC is (−0.5 (just attribution of A in AC) X−0.5 (AC delta))+(0.5 (just attribution of C in AC) X−0.5 (AC delta))=−0.25+−0.25=−0.5; just attribution of ABC is (0.4 (just attribution of A in ABC) X−0.25 (delta ABC))+(0.2 (just attribution of B in ABC) X−0.25 (delta ABC))+(0.4 (just attribution of C in ABC) X−0.25 (delta ABC)=−0.1+−0.05+−0.1=−0.25.

Next, if the original base rate is not 1, the factor additive analyzer 113 multiples the just attribution of each of the 7 volumes against the actual base rate resulting in seven individual products. The sum of the 7 products should equal the product result of the original equation.

Finally, the factor additive analyzer 113 sums the just attributions of each factor for each volume in which it participates to obtain each factors contribution in the equation to the result. In the current example, factor additive analyzer 113 calculates a sum of the just attributions for each factor as follows: total contribution value of A is −0.5 (just attribution for volume A of which A is 100% responsible for)+−0.1666666 (just attribution of A in AB)+−0.25 (just attribution of A in AC)+−0.1 (just attribution of A in ABC)˜=−1.0167; total contribution of B is 0.5 (just attribution for volume B of which B is 100% responsible for)+−0.83333 (just attribution of B in AB)+0.16667 (just attribution of B in BC)+−0.5 (just attribution of B in ABC)˜=0.5334; total contribution of C is 1 (just attribution for volume C of which C is 100% responsible for)+−0.25 (just attribution of C in AC)+0.16667 (just attribution of C in BC)+−0.1 (just attribution of C in ABC). The factor additive analyzer 113 adds the total contribution of each factor to ensure it matches 0.5 which is the sum of the premiums for factors A, B, and C because the result of the equation was 1.5 and the factors were responsible for an increase of 0.5. So, −1.0167+0.5334+0.9833˜=0.5.

The factor additive analyzer 113 multiplies each factor's total contribution value by the base to obtain a total amount attributed to each factor. The total contribution value can be provided in dollar values relative to the base.

Once the total contribution values of each of the factors of the equation are calculated, the factor additive analyzer 113 provides the contribution values of each factor to the network service 123 via API 114 and/or renders the total contribution values for each factor to the mobile app/browser 133 via user interface 115. This allows for increased feature function within network service 123 and/or user interface 115 of mobile app/browser 133. For example, users can change selections on coverage, attributes, and/or characteristics for selecting an insurance policy, which in turn shows the factor values derived from the users' selections. The user can also see the total contribution values for each factor. This permits the user to see why an insurance quote provided by an insurer's network service 123 does not reduce the quote as much as the user may have anticipated when the user changed selections to reduce factor values. This also permits actuaries to determine true impacts of changing how factor values are calculated on an overall insurance rate premium equation.

In an embodiment, the total contribution values of each factor in the equation can be integrated into workflows of the network services 123 via API 114 to provide the increased feature and function of the network services 123. In an embodiment, the total contribution values of each factor in the equation can be integrated into workflows of the mobile app/browser 133 via user interface 115 to provided increased feature and function of the mobile app/browser 133.

System 100 decomposes complex multiplication equations by factors to resolve a total contribution value of each of the factors. Comprehending and analyzing how each factor impacts the overall result is more easily achieved when a total contribution value of each factor in an equation is known. Additionally, the total contribution value of each factor can be used to demonstrate regulatory compliance to regulators with respect to the equations and the corresponding factors.

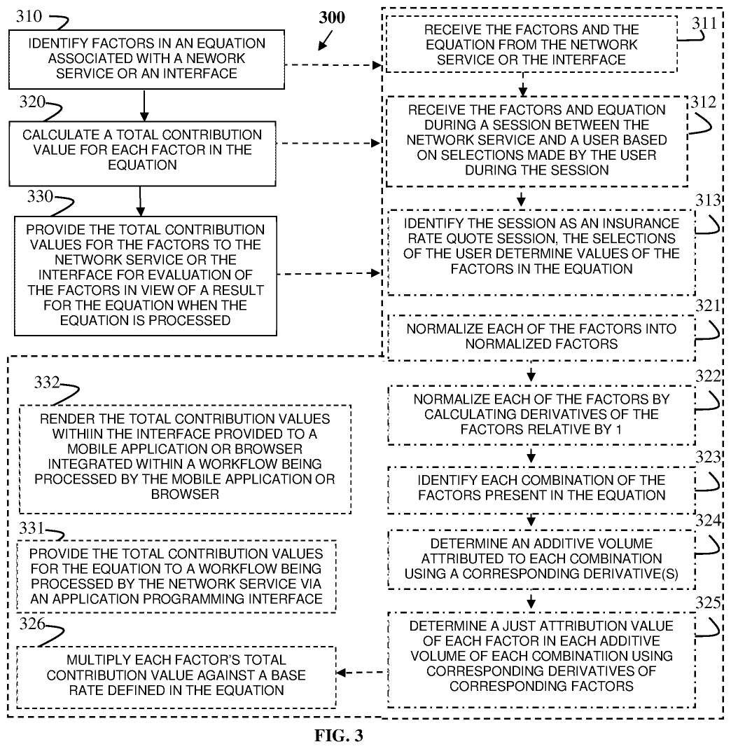

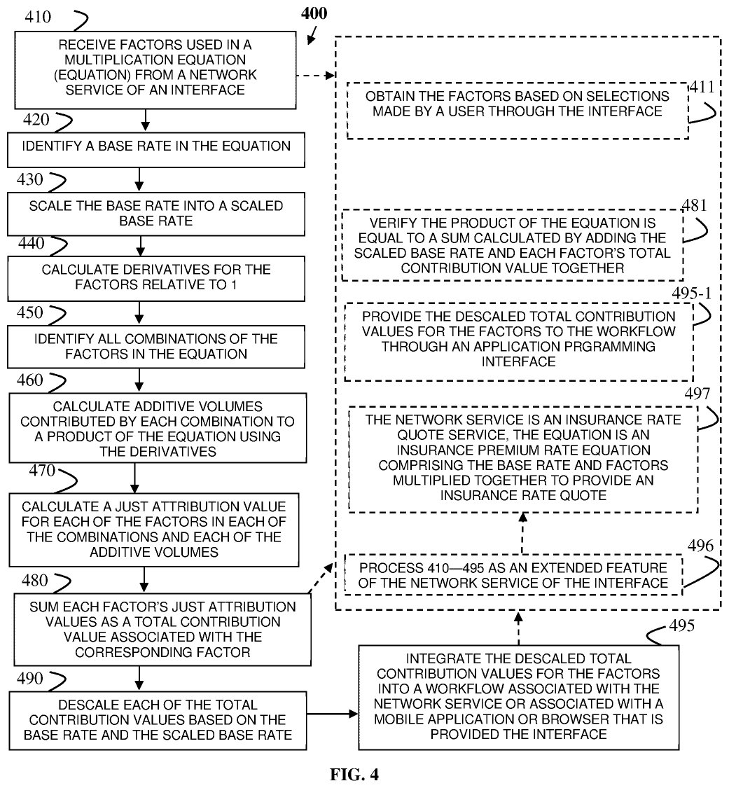

Although the above-discussed examples were presented within the context of insurance premium calculations, this does not have to always be the case as the invention can be used in many industries that rely on large factor-based and multiplication-based equations. The above-discussed embodiments and other embodiments are now discussed with reference to FIGS. 3 and 4.

FIG. 3 is a flow diagram of a method 300 for rendering additive values of factors in an equation via an interface, according to an example embodiment. The software module(s) that implements the method 300 is referred to as a “factor manager” The factor manager is implemented as executable instructions programmed and residing within memory and/or a non-transitory computer-readable (processor-readable) storage medium and executed by one or more processors of one or more devices. The processor(s) of the device(s) that executes the factor manager are specifically configured and programmed to process the factor manager. The factor manager may have access to one or more network connections during its processing. The network connections can be wired, wireless, or a combination of wired and wireless.

In an embodiment, the device that executes the factor manager is the cloud 110. In an embodiment, the device that executes the factor manager is server 110.

In an embodiment, the factor manager is all or some combination of 113, 114, and/or 115. The factor manager presents another and, in some ways, enhanced perspective of system 100.

At 310, the factor manager identifies factors in an equation associated with a network service 123 or an interface 115. In an embodiment, at 311, the factor manager receives the factors and the equation from the network service 123 or the interface 115. In an embodiment of 311 and at 312, the factor manager receives the factors and the equation during a session between the network service 123 and a user based on selection made by the user during the session. In an embodiment of 312 and at 323, the factor manager identifies the session as an insurance rate quote session; the selections of the users determine values of the factors in the equation.

At 320, the factor manager calculates a total contribution value of each factor in the equation. That is, each factor's total value added to the product of the equation is calculated.

In an embodiment, at 321, the factor manager normalizes each of the factors into normalized factors. In an embodiment of 321 and at 322, the factor manager normalizes each of the factors by calculating derivates of the factors relative to 1. For example, a factor less than 1 is calculated as (1/factor)−1 and a factor greater than 1 is calculated as factor−1.

In an embodiment of 322 and at 323, the factor manager identifies each combination of the factors present in the equation. Any given combination includes one or more factors; thus, each factor participates in a combination of 1 that just includes its corresponding factor, each factor is also in other combinations with each of the other factors and in a combination that includes all of the factors.

In an embodiment, of 323 and at 324, the factor manager determines an additive volume attributed to each combination using a corresponding derivative (i.e., normalized factor). In an embodiment of 324 and at 325, the factor manager determines a just attribution value for each factor in each additive volume of each combination using corresponding derivatives of corresponding factors. In an embodiment of 325 and at 326, the factor manager multiples each factor's total contribution value against a base rate defined in the equation.

At 330, the factor manager provides the total contribution values for the factors to the network service 123 or the interface 115 for evaluation of the factors in view of a result or product for the equation when the equation is processed.

In an embodiment, at 331, the factor manager provides the total contribution values for the equation to a workflow being processed by the network service 123 via an API 114. In an embodiment, at 332, the factor manager renders the total contribution values within the interface 115 provided to a mobile application/browser 133 within a workflow being processed by the mobile application/browser 133.

FIG. 4 is a flow diagram of another method 400 for providing additive values of factors in an equation, according to an example embodiment. The software module(s) that implements the method 400 is referred to as a “factor analyzer and integrator.” The factor analyzer and integrator is implemented as executable instructions programmed and residing within memory and/or a non-transitory computer-readable (processor-readable) storage medium and executed by one or more processors of one or more devices. The processors that execute the factor analyzer and integrator are specifically configured and programmed to process the factor analyzer and integrator. The factor analyzer and integrator may have access to one or more network connections during its processing. The network connections can be wired, wireless, or a combination of wired and wireless.

In an embodiment, the device that executes the factor analyzer and integrator is the cloud 110. In an embodiment, the device that executes the factor analyzer and integrator is server 110.

In an embodiment, the factor analyzer and integrator is all of, or some combination of 113, 114, 115, 123, 133, and/or method 300. The factor analyzer and integrator presents another and, in some ways, enhanced processing perspective of system 100 and/or method 300.

At 410, the factor analyzer and integrator receives factors used in a multiplication equation (equation) from a network service 123 or an interface 115. In an embodiment, at 411, the factor analyzer and integrator obtains the factors based on selections made by the user through the interface 115.

At 420, the factor analyzer and integrator identifies a base rate in the equation. At 430, the factor analyzer and integrator scales the base rate into a scaled based rate.

At 440, the factor analyzer and integrator calculates derivatives for the factors relative to 1. At 450, the factor analyzer and integrator identifies all combinations of the factors in the equation. Again, each factor includes a combination in which that factor is the only factor in the combination.

At 460, the factor analyzer and integrator calculates additive volumes contributed by each combination to a product of the equation using the derivatives. At 470, the factor analyzer and integrator calculates a just attribution value for each of the factors in each of the combinations and for each of the additive volumes.

At 480, the factor analyzer and integrator sums each factor's just attribution values as a total contribution value associated with the corresponding factor. In an embodiment, at 481, the factor analyzer and integrator verify the product of the equation is equal to a sum calculated by adding the scaled base rate and each of the factor's total contribution value together.

At 490, the factor analyzer and integrator descales each of the total contribution values based on the base rate and the scaled base rate. Thus, each of the factors can be expressed as dollar amounts based on the descaling of the base rate.

At 495, the factor analyzer and integrator integrates the descaled total contribution values for the factors into a workflow associated with the network service 123 or associated with a mobile application/browser 133 that is provided the interface 115. In an embodiment, at 495-1, the factor analyzer and integrator provides the descaled total contribution values for the factors to the workflow through an API 114.

In an embodiment, at 496, the factor analyzer and integrator (410-495) processes as an extended feature of the network service 123 or the interface 115. In an embodiment of 496 and at 497, the network service 123 is an insurance rate quote service; the equation is an insurance premium rate equation that includes the base rate and the factors multiplied together to provide an insurance rate quote as the product of the equation.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus, the following claims are hereby incorporated into the Description of the Embodiments, with each claim standing on its own as a separate exemplary embodiment.

1. A method, comprising:
identifying factors in an equation associated with a network service or an interface;
calculating a total contribution value for each factor in the equation; and
providing the total contribution values for the factors to the network service or the interface for evaluation of the factors in view of a result for the equation when the equation is processed.

2. The method of claim 1, wherein identifying further includes receiving the factors and the equation from the network service of the interface.

3. The method of claim 2, wherein identifying further includes receiving the factors and the equation during a session between the network service and a user based on selections made by the user during the session.

4. The method of claim 3, wherein identifying further includes identifying the session as an insurance rate quote session, wherein the selections of the user determine values of the factors in the equation.

5. The method of claim 1, wherein calculating further includes normalizing each of the factors into normalized factors.

6. The method of claim 5, wherein normalizing further includes normalizing each of the factors by calculating derivatives of the factors relative to 1.

7. The method of claim 6, wherein normalizing further includes identifying each combination of the factors present in the equation, wherein any given combination includes one or more of the factors.

8. The method of claim 7, wherein identifying the combinations further include determining an additive volume attributed to each combination using a corresponding derivative or corresponding derivatives.

9. The method of claim 8, wherein determining further includes determining a just attribution value of each factor in each additive volume of each combination using corresponding derivatives of corresponding factors.

10. The method of claim 9, wherein determining the just attribution values further includes summing each factor's corresponding just attribution values to obtain a corresponding total contribution value for the corresponding factor, wherein summing further includes multiplying each factor's total contribution value against a base rate defined in the equation.

11. The method of claim 1, wherein providing further includes providing the total contribution values for the equation to a workflow being processed by the network service via an application programming interface.

12. The method of claim 1, wherein providing further includes rendering the total contribution values within an interface provided to a mobile application or a browser integrated within a workflow being processed by the mobile application or the browser.

13. A method, comprising:
receiving factors used in a multiplication equation from a network service or an interface;
identifying a base rate in the multiplication equation;
scaling the base rate into a scaled base rate;
calculating derivatives for the factors relative to 1;
identifying all combinations of the factors in the multiplication equation, wherein any given combination includes at least one factor;
calculating additive volumes contributed by each combination to a product of the multiplication equation using the derivatives;
calculating a just attribution value for each of the factors in each of the combinations and each of the additive volumes;
summing each factor's just attribution values as a total contribution value associated with a corresponding factor;
descaling each of the total contribution values based on the base rate and the scaled base rate; and
integrating the descaled total contribution values for the factors into a workflow associated with the network service or associated with a mobile application or a browser that is provided the interface.

14. The method of claim 13 further comprising, processing the method as an extended feature of the network service of the interface.

15. The method of claim 14, wherein the network service is an insurance rate quote service, and wherein the multiplication equation is an insurance premium rate equation comprising the base rate and factors multiplied together to provide an insurance rate quote.

16. The method of claim 13, wherein receiving further includes obtaining the factors based on selections made by a user through the interface.

17. The method of claim 13, wherein summing further includes verifying the product of the equation is equal to a sum calculated by adding the scaled base rate and each factor's total contribution value together.

18. The method of claim 13, wherein integrating further includes providing the descaled total contribution values for the factors to the workflow via an application programming interface (API).

19. A system, comprising:
at least one server system comprising at least one server having at least one processor and a non-transitory computer-readable storage medium having executable instructions;
the executable instructions when executed by the at least one processor cause the at least one processor to perform operations comprising:
identifying factors of an equation, wherein the equation includes a base rate multiplied by the factors;
determining all combinations of the factors, wherein any given factor includes one or more of the factors;
determining an additive value associated with a product of the equation provided by each factor in each combination;
summing each factor's additive values to obtain a total contribution value for a corresponding factor; and
integrating the total contribution values for the factors into a network service or an interface associated with the equation.

20. The system of claim 19, wherein the equation is an insurance rate quote equation provided to a user through the network service of the interface.
